(19) United States
(12) Patent Application Publication
(10) Pub. No.: US 2017/0046160 A1
(43) Pub. Date: Feb. 16, 2017

(54) EFFICIENT HANDLING OF REGISTER FILES

(71) Applicant: QUALCOMM Incorporated, San Diego, CA (US)

(72) Inventors: Kiran Ravi SETH, Morrisville, NC (US); Rodney Wayne SMITH, Raleigh, NC (US); Yusuf Cagatay TEKMEN, Raleigh, NC (US); Raghaven MADHAVAN, Cary, NC (US)

(21) Appl. No.: 15/086,055

(22) Filed: Mar. 31, 2016

Related U.S. Application Data
(60) Provisional application No. 62/205,614, filed on Aug. 14, 2015.

(51) Int. Cl. G06F 9/38; G06F 9/30

(52) U.S. Cl. CPC G06F 9/384; G06F 9/30098

(57) ABSTRACT

Systems and methods of handling a register file include, in a first instruction set architecture (ISA) mode assigning a first subset of tracking resources to logical registers of a first logical register subset for tracking mappings to full granularity and first lower granularity physical registers of a first physical register subset, and assigning a second subset of tracking resources to logical registers of a second logical register subset for tracking mappings to second lower granularity physical registers of the first physical register subset. The second subset of tracking resources are configured for tracking at least the logical registers of the second logical register subset mappings to physical registers of a second physical register subset in a second ISA mode, wherein the second physical register subset is available to the second ISA mode but not the first ISA mode.

### CLAIM OF PRIORITY UNDER 35 U.S.C. §119

The present Application for patent claims priority to Provisional Application No. 62/205,614 entitled “EFFICIENT HANDLING OF REGISTER FILES” filed Aug. 14, 2015, and assigned to the assignee hereof and hereby expressly incorporated by reference herein.

### FIELD OF DISCLOSURE

Disclosed aspects relate to register files used in processing systems. More specifically, exemplary aspects relate to efficient handling of register files across different instruction set architecture (ISA) modes.

### BACKGROUND

In out-of-order (OOO) processors, instructions may be executed out of program order. There may be dependencies between registers used by different instructions which can lead to hazards when the instructions are executed out of program order. Register renaming is used to alleviate problems associated with register dependencies. A large physical register file (PRF), which is a hardware structure comprising a large number of physical registers, may be available for temporary data storage in a processor. However, a smaller number of registers known as architectural or logical registers are made available to instructions executing on the processor to achieve compact instruction encoding and higher software efficiency. For example, to execute a program in a processor, a compiler may transform the program into assembly instructions. The assembly instructions may include or refer to names of logical registers in their encoding. However, the small number of logical registers can lead to register name dependencies (also known as false dependencies) which can limit the size of an instruction window (i.e., number of instructions being actively processed in a pipeline), because more than one instruction in the window may access the same logical register.

To combat this limitation, register renaming may be employed, wherein the names or identifiers of the logical registers (or logical register names) are mapped to names of the physical registers (or physical register names). Translations from logical to physical register names may be handled by a hardware table called a register rename table (RRT) or a rename map table (RMT). This hardware renaming mechanism may be invisible to software (e.g., the compiler). Based on the renaming, the instructions may effectively write their generated results or outputs (also known as productions) to the physical registers (which are part of the PRF, as previously mentioned). Any future consumers of these productions can also read the same physical registers. Since the number of physical registers available exceeds the number of logical registers, the renaming from logical to physical register names can alleviate the limitations imposed by dependencies.

In a conventional implementation, the rename map table (RMT) may include a table with a number of entries corresponding to the number of logical registers available in an instruction set architecture (ISA). Each entry of the RMT may be indexed using a logical register name to obtain the current mapping of the logical register name to a physical register name. Each entry may also include other attributes (e.g., granularity of access, as will be discussed further below) associated with the physical register name. Corresponding tracking resources (e.g., a “ready file” to show whether a certain physical register is available, a “free list” to keep track of free (i.e., not in active use) physical registers, etc.) may also be made available for tracking the mappings of logical to physical register names in the RMT.

In some cases, more than one ISA mode may be supported by a processor, wherein each ISA mode may have a corresponding set of dedicated or assigned logical registers. For example, in the ARM® (registered trademark of ARM Ltd., hereinafter, “ARM”) ISA, at least a 32-bit mode (also referred to as a “single-precision,” “lower granularity,” or “A32” mode in this disclosure) and a 64-bit mode (also referred to as a “double-precision,” “higher granularity,” or “A64” mode in this disclosure) may be available. Each ISA mode may support or allow different types of register file accesses.

For example, a subset of physical registers in a PRF of an ARM processor may be available to for use in the A32 mode. Whereas, a different subset (or in some cases, all of the physical registers) may be available for use in the A64 mode, but not in the A32 mode. Thus, a smaller number of physical registers may be available to the A32 mode than are available in the A64 mode. Correspondingly, tracking resources for physical registers that are not available in the A32 mode may go unused when the ARM processor is executing instructions in the A32 mode. The unused tracking resources may be turned off (powered down) in the A32 mode to reduce power consumption.

In the ARM architecture, the physical registers of the PRF may be double-precision or 64-bits wide. In general, logical registers specified in an A32 mode instruction may be of different granularities (e.g., 32-bits or 64-bits), while logical registers specified in an A64 mode may only be 64-bits wide. Correspondingly, accessing physical registers in the A32 mode can involve accessing only the upper 32-bit half or lower 32-bit half of a 64-bit register or accessing the entire 64-bit register. The aforementioned attributes may be introduced in the RMT to aid in tracking granularity of access (e.g., 32-bits or 64-bits). For example, several attributes may be provided to indicate whether a particular entry of the RMT is mapped to the upper half, lower half, or full (i.e., the entire 64-bits), for a 64-bit physical register.

Additional resources may also be provided to perform partial accesses (e.g., either the upper half or the lower half) of the 64-bit registers. For example, writing only 32-bits to a 64-bit physical register may involve a read-modify-write process, wherein, the previously stored 64-bits of a physical register are read and temporarily stored, and the new 32-bits are written to one half and the temporarily stored 32-bits are written back to the other half of the physical register.

In conventional implementations, the attributes (to indicate lower/upper half or full access) and additional support structures for partial access of register files are provided for all logical registers which can map to the subset of physical registers available to the A32 mode instructions. However, tracking resources for physical registers which are not available to the A32 mode instructions go unused when the processor is in the A32 mode.

### SUMMARY

Exemplary aspects of the invention are directed to systems and method for handling register file use in different instruction set architecture (ISA) modes, wherein each ISA mode may have a corresponding set of logical registers. In exemplary aspects of this disclosure, a first subset of physical registers may be available to a first ISA mode (e.g., A32 mode) and a second subset of physical registers may be available to a second ISA mode (e.g., A64 mode) but not to the first ISA mode (but in some aspects, the first subset of physical registers may also be available to the second ISA mode). A physical register file may comprise at least a combination (e.g., sum) of the first and second subsets of physical registers. A first subset of tracking resources may be available for tracking mappings of a first subset of logical registers to the first subset of physical registers and a second subset of tracking resources may be available for tracking mappings of a second subset of logical registers to the second subset of physical registers. In exemplary aspects, the second subset of tracking resources may be made available to the first ISA mode. For example, in the first ISA mode, the first subset of tracking resources may be used for a first partial access (e.g., to lower half) or full access of the first subset of physical registers, while the second subset of tracking resources may be used for a second partial access (e.g., upper half) of the first subset of physical registers. Thus, resources (e.g., attributes) provided for the first ISA mode can be reduced by using resources available anyway in the second ISA mode (but not conventionally used in the first ISA mode).

For example, an exemplary aspect pertains to a method of operating a processor, the method comprising, in a first instruction set architecture (ISA) mode, assigning a first subset of tracking resources to logical registers of a first logical register subset for tracking mappings to full granularity physical registers and first lower granularity physical registers of a first physical register subset and assigning a second subset of tracking resources to logical registers of a second logical register subset for tracking mappings to second lower granularity physical registers of the first physical register subset. The second subset of tracking resources are configured for tracking at least mappings of the logical registers of the second logical register subset to physical registers of a second physical register subset in a second ISA mode, wherein the second physical register subset is available to the second ISA mode but not the first ISA mode.

Another exemplary aspect pertains to apparatus comprising a processor configured to operate in a first instruction set architecture (ISA) mode or a second ISA mode, wherein the processor comprises a rename map table (RMT) configured to track logical register names to physical register names of physical registers of a physical register file (PRF). The RMT comprises a first subset of tracking resources configured to track mappings of logical registers of a first logical register subset to full granularity physical registers and first lower granularity physical registers of a first physical register subset of the PRF in the first ISA mode, and a second subset of tracking resources configured to track mappings of logical registers of a second logical register subset to second lower granularity physical registers of the first physical register subset of the PRF in the first ISA mode. The second subset of tracking resources are configured to track at least mappings of the logical registers of the second logical register subset to physical registers of a second physical register subset of the PRF in the second ISA mode, wherein the second physical register subset is available to the second ISA mode but not the first ISA mode.

Yet another exemplary aspect is directed to an apparatus comprising means for executing instructions in a first instruction set architecture (ISA) mode or a second ISA mode. The means for executing comprises a first means for tracking assigned to logical registers of a first logical register subset, for tracking mappings to full granularity physical registers and first lower granularity physical registers of a first physical register subset in the first ISA mode and a second means for tracking assigned to logical registers of a second logical register subset, for tracking mappings to second lower granularity physical registers of the first physical register subset in the first ISA mode. The second means for tracking for tracking comprises means for tracking at least mappings of the logical registers of the second logical register subset to physical registers of a second physical register subset in the second ISA mode, wherein the second physical register subset is available to the second ISA mode but not the first ISA mode.

Another exemplary aspect is directed to a non-transitory computer-readable storage medium comprising code, which, when executed by a processor, causes the processor to manage tracking resources for logical registers in first and second instruction set architecture (ISA) modes, the non-transitory computer-readable storage medium comprising, in the first ISA mode, code for assigning a first subset of tracking resources to logical registers of a first logical register subset for tracking mappings to full granularity physical registers and first lower granularity physical registers of a first physical register subset, and code for assigning a second subset of tracking resources to logical registers of a second logical register subset for tracking mappings to second lower granularity physical registers of the first physical register subset. In the non-transitory computer-readable storage medium, the second subset of tracking resources are configured for tracking at least mappings of the logical registers of the second logical register subset to physical registers of a second physical register subset in a second ISA mode, wherein the second physical register subset is available to the second ISA mode but not the first ISA mode.

### BRIEF DESCRIPTION OF THE DRAWINGS

The accompanying drawings are presented to aid in the description of aspects of the invention and are provided solely for illustration of the aspects and not limitation thereof.

FIG. 1 illustrates a schematic view of a processor configured according to disclosed aspects.

FIG. 2 illustrates aspects of the processor of FIG. 1, according to exemplary aspects.

FIG. 3 illustrates a method of managing a hierarchical register file system according to aspects of this disclosure.

FIG. 4 illustrates an exemplary computing device 400 in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In exemplary aspects of this disclosure, a first subset of physical registers may be available to a first ISA mode (e.g., A32 mode) and a second subset of physical registers may be available to a second ISA mode (e.g., A64 mode) but not to the first ISA mode (but in some aspects, the first subset of physical registers may also be available to the second ISA mode). A physical register file may comprise at least a combination (e.g., sum) of the first and second subsets of physical registers. A first subset of tracking resources may be available for tracking mappings of a first subset of logical registers to the first subset of physical registers and a second subset of tracking resources may be available for tracking mappings of a second subset of logical registers to the second subset of physical registers. In exemplary aspects, the second subset of tracking resources may be made available to the first ISA mode. For example, in the first ISA mode, the first subset of tracking resources may be used for a first partial access (e.g., to lower half) or full access of the first subset of physical registers, while the second subset of tracking resources may be used for a second partial access (e.g., upper half) of the first subset of physical registers. Thus, resources (e.g., attributes) provided for the first ISA mode can be reduced by using resources which are already available in the second ISA mode (but not conventionally used in the first ISA mode).

In this disclosure, A32 mode and A64 mode of an ARM ISA are used as examples to explain exemplary features, but it will be understood that the disclosed aspects may pertain to at least any first and second ISA modes of exemplary processors, without restrictions based on particular ISAs, register sizes, etc.

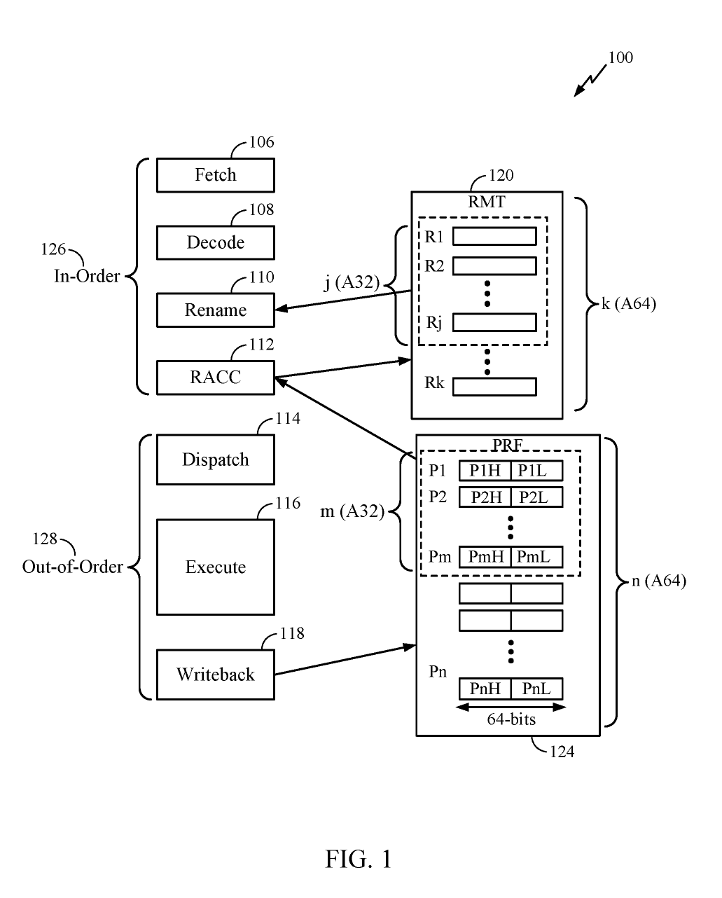

To aid in the understanding of aspects of this disclosure, an instruction pipeline of processor 100 (e.g., designed to support the ARM architecture) will be briefly described with reference to the schematic diagram of FIG. 1. In general, processor 100 may be an OOO processor with in-order stages 126 and OOO stages 128 of an instruction pipeline used for executing instructions in processor 100. Also shown in FIG. 1 are rename map table (RMT) 120 and physical register file (PRF) 124. Various other aspects which may be present in processor 100 but not particularly relevant to this disclosure, are not shown or described in detail, as they will be understood by one skilled in the art.

In-order stages 126 comprise fetch 106, decode 108, rename 110, and register access (RACC) 112 stages. In fetch stage 106, an instruction fetch unit (not shown) of processor 100, for example, fetches instructions (in any ISA mode, e.g., A32 or A64), from an instruction cache (not shown in this view). In decode stage 108, a decode unit (not shown) of processor 100, for example decodes the instructions to determine an instruction's operation code (or “op-code”), and identify operands (e.g., source and destination registers), wherein the operands may be expressed in terms of logical register names.

As previously described, there may be dependencies between various instructions executed in processor 100. To handle these dependencies, in rename stage 110, logical registers may be renamed. For example, rename map table (RMT) 120 may be used to track mappings of logical register (source/destination) names to physical register names. As shown, there may be “k” logical registers, labeled R1-Rk, which can be mapped to “n” physical registers P1-Pn of PRF 124. Of these, a first subset of “j” logical registers R1-Rj can map to a first subset of “m” physical registers P1-Pm which are assumed to be available for use by A32 mode instructions in one example. For convenience, the first subsets of logical and physical registers have been illustrated as belonging to a block of consecutive registers, but it will be understood that this may not be the case in some examples. While in one example, all k logical registers R1-Rk which map to n physical registers P1-Pn may be available for A64 mode instructions, a second subset (which does not include the first subset) of k-j logical registers can map to a second subset (which does not include the first subset) of n-m physical registers, wherein the second subset of k-j logical and the second subset of n-m physical registers may not be available for use by A32 mode instructions. However, tracking resources (e.g., attributes, free lists, ready files, etc.) pertaining to these second subsets of logical and physical registers may be repurposed for use by A32 mode instructions in exemplary aspects of this disclosure, as will be further explained in the following sections.

Continuing with the description of the instruction pipeline of processor 100, in RACC stage 112, processor 100 reads the physical registers corresponding to the source operands or source logical register names from PRF 124. The specific access of PRF 124 will depend on whether the instructions are A32 mode or A64 mode as will be discussed in further detail below. Although not shown, a ready file and/or valid bits may be used along with the physical registers P1-Pn of PRF 124 to indicate whether corresponding physical registers P1-Pn are valid, and only valid physical registers of physical registers P1-Pn may be read in RACC stage 112. If a particular physical register is not ready or not valid, it is possible that that physical register will be updated or written to by an instruction which is in-flight (i.e., whose execution is not completed). For such physical registers which are not ready, forwarding paths (not shown) may be used to provide the latest values of the corresponding physical registers as soon as they become available.

Coming now to OOO stages 128: dispatch 114, execute 116, and write back 118 stages are shown. In dispatch stage 114, instruction(s) are dispatched to execution units (not shown) of processor 100, after identifying and possibly arbitrating among instructions that have all their source operands ready, and for which an appropriate execution unit is available. In execute stage 116, the dispatched instruction is executed in the execution unit and a result is generated. In write back stage 118, the dispatched instruction's result or production is written to the appropriate physical register (in PRF 124), which was assigned to the instruction in the rename stage 110. In addition, during write back stage 118, processor 100 also writes or sets an entry corresponding to the physical register in the ready file or updates a valid bit to indicate that the corresponding physical register is now valid and contains the latest production. Also in the write back stage 118, the production may be forwarded (e.g., through an aforementioned forwarding path) to a consumer instruction which has passed a certain pipeline stage (e.g., RACC stage 112).

Particular cases for A32 and A64 mode instructions will now be considered in the above framework of processor 100's instruction pipeline. The mode of operation of processor 100 can be dynamically changed between at least the A32 and A64 modes (specific mechanisms for controlling and dynamically changing the mode will not be described in this disclosure). When a mode change occurs, there may be corresponding changes in the resources available for execution of instructions in the new mode. As previously mentioned, the resources available to A32 mode instructions are less than the resources which are originally designated as available to A64 mode instructions, for example, based on the ARM architecture.

In more detail, PRF 124 may comprise n 64-bit physical registers P1-Pn. Each of these 64-bit physical registers is shown to comprise an upper 32-bit half (e.g., P1H-PnH) and a lower 32-bit half (e.g., P1L-PnL). An A64 instruction is assumed to only be able to read or write the full 64-bits of any of the n 64-bit physical registers P1-Pn, for the purposes of this discussion. Correspondingly, all k logical registers R1-Rk which can be mapped by RMT 120 to the n physical registers P1-Pn are assumed to be available for A64 instructions to use.

However, an A32 instruction may read or write to the upper 32-bit half, lower 32-bit half, or the full 64-bits of the first subset of m physical registers P1-Pm (where, it is understood that m<n). Correspondingly, only a smaller number of j logical registers may be used to map to the first subset of m physical registers P1-Pm. An exact correlation between the numbers of logical and physical registers (i.e., j and m) in the corresponding first subsets of logical and physical registers is not assumed, but for the sake of this discussion, m<n and j<k.

In general, the total number of logical registers (k) may be smaller (e.g., one-third or one-fourth) of the total number of physical registers (n). The size of each entry of RMT 120 may be big enough to hold an indication (e.g., physical register name) of the n physical registers P1-Pn to which the logical registers map to. Additionally, each entry of RMT 120 may also have associated attributes, e.g., to represent mode or corresponding granularity. Moreover, for A32 instructions, separate attributes may be used to clarify whether a particular logical register R1-Rj maps to an upper half, lower half, or entire physical register P1-Pm. The number of attributes and corresponding support structures may increase cost and complexity of processor 100. Therefore, some of the cost and complexity can be reduced by repurposing tracking resources available in A64 mode but not in A32 mode when a mode change takes place from A64 to A32.

To illustrate tracking mechanisms which may be used to prevent hazards which can arise due to true dependencies and save on costs for preventing fake dependencies, the following example code sequence of A32 instructions will be considered wherein logical registers R1, R2, R3, R4, R5, R6, R7 are assumed to be mapped to physical registers P1, P2, P3, P4, P5, P6, and P7 respectively (keeping in mind that in a realistic scenario, there may not be a sequential correlation as above between logical register names and the physical register names that the logical register names are mapped to, e.g., in RMT 120). Each physical register P1-P7 comprises corresponding upper halves P1H-P7H and lower halves P1L-P7L, respectively. Correspondingly, since A32 instructions can involve reads and writes of 32-bit and 64-bit granularities, the code sequence below follows the nomenclature that the logical register name with suffix L, e.g., R1L maps to corresponding lower 32-bits of physical register P1, i.e., P1L; suffix H, e.g., R1H maps to corresponding upper 32-bits of physical register P1, i.e., P1L; and a logical register name without any suffixes (L/H), e.g., simply “R1” refers to an entire 64-bit physical register (in this case, P1, which includes P1H and P1L, or [P1H:P1L]). The example A32 code sequence is as follows, where for each instruction I0-I4, the function to be performed is listed (e.g., addition (ADD)/subtraction (SUB)), followed by one destination register name, followed by two source register names.

### I0: ADD R1, R2, R3

### I1: ADD R1L, R4L, R5L

### I2: ADD R1H, R6H, R7H

### I3: SUB R2L, R1H, R4H

### I4: ADD R4, R5, R1

Focusing on logical registers R1, R1L and R1H in the above instructions, it is seen that there is a true data dependency between instructions I0 and H. Instruction I0 specifies that the result of adding source registers R2 and R3 should be placed in a 64-bit physical register (P1) to which destination register R1 is mapped to. Instruction I1 specifies that only the lower half, P1L corresponding to destination register R1L be written with the addition of source registers R4L and R5L. If instruction I1 is executed before I0 (since processor 100 supports OOO execution), then the update to P1L from I1 would be overwritten by the write to the entire 64-bits of P1 by I0, leading to a write-after-write (WAW) hazard. This is a true data dependency which may be avoided by implementing tracking mechanisms.

On the other hand, considering instructions I1 and I2, I1 writes to P1L while I2 writes to P1H, which means that there is no real true dependency between I1 and I2. However, in conventional implementations, writing P1L or P1H involves reading the entire 64-bits of P1 before corresponding lower or upper halves of P1 can be written (e.g., by the aforementioned read-modify-write process). Therefore, if instructions I1 and I2 were executed out of program order, a read-after-write (RAW) hazard may arise. However, this RAW hazard is not a true dependency but referred to as a fake dependency or fake RAW hazard since the hazard only arises due to the conventional implementations of A32 instructions. In exemplary aspects, fake hazards can be prevented without involving tracking mechanisms to track the fake hazards. Furthermore, conventional implementations may allow reading only the entire physical register, which means that to retrieve the upper half (e.g., P1H), the upper half may be shifted into the lower position and read out. In exemplary aspects the shift to put data in an expected half/location can also be avoided.

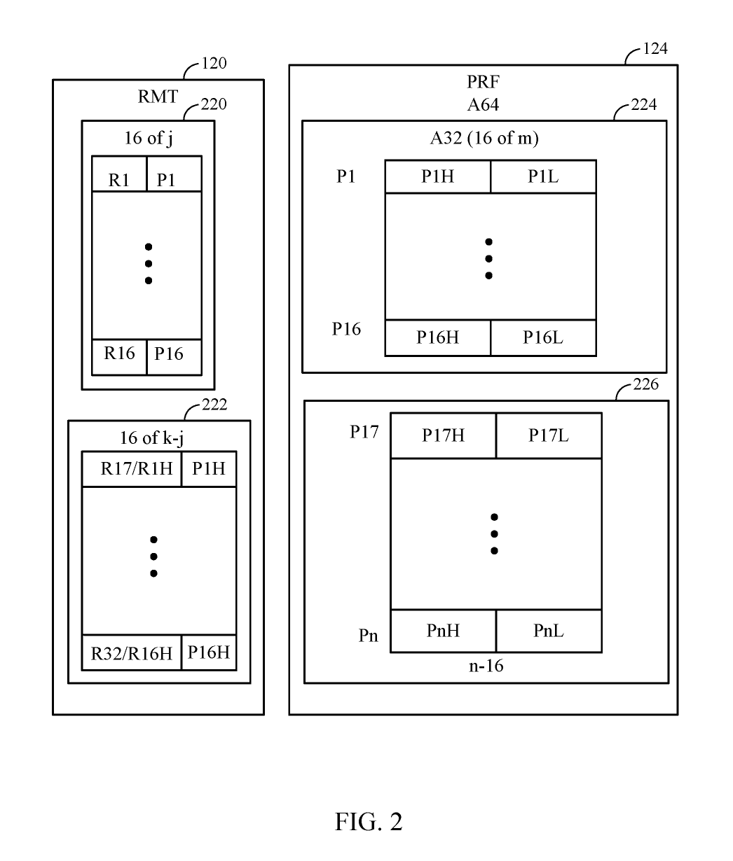

With reference now to FIG. 2, an exemplary configuration of RMT 120 and corresponding tracking resources is illustrated. FIG. 2 illustrates an example where specific numerical values have been shown for ease of understanding. It will be understood that these numerical values are merely exemplary and not to be construed as limiting the scope of this disclosure. Accordingly, a first physical register subset 224 comprising 16 physical registers P1-P16 out of the m physical registers P1-Pm available for A32 instructions have been shown in PRF 124. Again, purely for the sake of convenience, corresponding sequential order has been maintained in showing a first logical register subset 220 comprising 16 logical register R1-R16 of the j logical registers R1-Rj mapped to physical registers of the first physical register subset 224 comprising physical registers P1-P16. First logical register subset 220 comprises 16 entries indexed by logical registers R1-R16 which hold attributes and tracking resources associated with tracking the mappings of full 64-bit (or full/higher granularity) logical registers R1-R16 to corresponding 64-bit physical registers P1-P16. First logical register subset 220 also comprises tracking resources for lower granularity accesses (e.g., corresponding to lower halves R1L-R16L in this case). In other words, attributes for these entries can simply specify granularity of access to determine whether P1-P16 are accessed or P1L-P16L are accessed. Separate attributes can be avoided for tracking P1-P16, P1L-P16L, and P1H-P16H as in conventional implementations.

Second physical register subset 226 comprises n−16 physical registers depicted (for the sake as convenience) as P17-Pn. Physical registers P17-Pn are not available for access in A32 mode. Correspondingly, k-j logical registers and related tracking resources are also not conventionally available for use in A32 mode. Of these k-j logical registers, 16 logical registers R17-R32 are shown as belonging to second logical register subset 222 (some more logical registers of the k logical registers may still be available to the A64 mode but not the A32 mode, but these are not specifically illustrated in FIG. 2). Tracking resources related to the 16 logical registers R17-R32 are repurposed in exemplary aspects. Specifically, tracking resources for logical registers R17-R32 of the second logical register subset 222 are used for tracking the upper halves R1H-R16H of first logical register subset 220, which map to P1H-P16H of the first physical register subset 224. To convey that tracking resources are shared in this manner, FIG. 2 illustrates 16 entries indexed by logical registers R17/R1H-R32/R16H as holding attributes and tracking resources associated with physical registers P1H-P16H of the first physical register subset 224.

Accordingly, in the previously described A32 mode code sequence, the first logical register subset 220 of RMT 120 may be used for tracking register R1 and R1L in instructions I0 (ADD R1, R2, R3) and I1 (ADD R1L, R4L, R5L). An attribute which indicates granularity may indicate whether the corresponding physical register is P1 or P1L. In an aspect, the default granularity may be full granularity (64-bits). Therefore, a write to the full granularity logical register R1 (e.g., instruction I0) will update attributes and tracking information for both P1L and P1H associated with R1, as a default. A full granularity read of the logical register R1 (e.g., for instruction I4: ADD R4, R5, R1), corresponding data may be read from physical registers P1L and P1H, as a default.

On the other hand, logical register R17 of the second logical register subset 222 of RMT 120 may be used for tracking register R1H in instruction I2 (ADD R1H, R6H, R7H), which may map to physical register P1H as a default, without the use of further attributes to specify granularity in the A32 mode.

Accordingly, lower granularity writes (e.g., to R1L or R1H) may be simplified. Since the specific half of the physical register P1 (e.g., P1L or P1H) can be written to, a read-modify-write process as previously described, can be avoided. Attributes can be correspondingly updated for the particular half (e.g., the entry for logical register R1 and R17, respectively). Thus, performance of lower granularity writes (e.g., a sequence of lower granularity writes) can be comparable to performance of full granularity writes (e.g., a sequence of full granularity writes). As seen, in exemplary aspects, writing to a first lower granularity physical register (e.g., P1L) or a second lower granularity physical register (e.g., P1H) can be based on a first subset of tracking resources (e.g., tracking resources for logical register R1 of the first logical register subset 220) or a second subset of tracking resources (e.g., tracking resources for logical register R17 of the second logical register subset 222), respectively. More specifically, processor 100 may include write logic (not specifically shown), for example, for writing to the first lower granularity physical register or the second lower granularity physical register, without performing a read-modify process comprising first reading data stored in the first lower granularity physical register or the second lower granularity physical register, respectively.

In cases where a lower granularity read (e.g., of R1L or R1H) follows a lower granularity write (e.g., of R1L or R1H), the attributes and tracking mechanisms for R1 or R17 may be used for tracking specific dependencies for P1L or P1H, respectively, rather than for the entire physical register P1. Where pertinent, the data value can be shifted (e.g., the upper 32-bits P1H to the lower 32-bits to be supplied to a 32-bit read operation of source register R1H). Thus, in exemplary aspects, processor 100 can include read logic (not shown) for reading from a first lower granularity physical register (e.g., P1L) or a second lower granularity physical register (e.g., P1H) based on a first subset of tracking resources (e.g., tracking resources for logical register R1 of the first logical register subset 220) or a second subset of tracking resources (e.g., tracking resources for logical register R17 of the second logical register subset 222), respectively, wherein in some cases, the read logic can further involve shift logic to shift data read from the second lower granularity physical register P1H to the first lower granularity physical register P1L for a lower granularity read operation (e.g., of source register R1H).

A lower granularity write (e.g., of R1L or R1H) will update attributes to reflect the mappings of R1 or R17, respectively, to corresponding physical registers (e.g., P1L or P1H).

Additional considerations may arise in cases where a full granularity read of the logical register R1 (e.g., instruction 14: ADD R4, R5, R1) follows a lower granularity write (e.g., instructions I1 ADD R1L, R4L, R5L and I2: ADD R1H, R6H, R7H). In these cases, execution of instructions I1 and I2 may have caused P1L and P1H to be updated and the updated data values of P1 formed by P1L and P1H are to be read by instruction I4 when the instructions I1, I2, . . . , I4 are executed in program order. However, since these instructions may be executed out of order, attributes and tracking mechanisms for both the upper and lower halves (i.e., for logical registers R1 and R17) may be utilized to track data dependencies and resolve any RAW hazards. Thus, full granularity reads may involve consolidating data from lower gravity writes, but this may not affect performance much, because switching between lower and full granularity operations may be rare in code sequences found in programs executed on ARM processors.

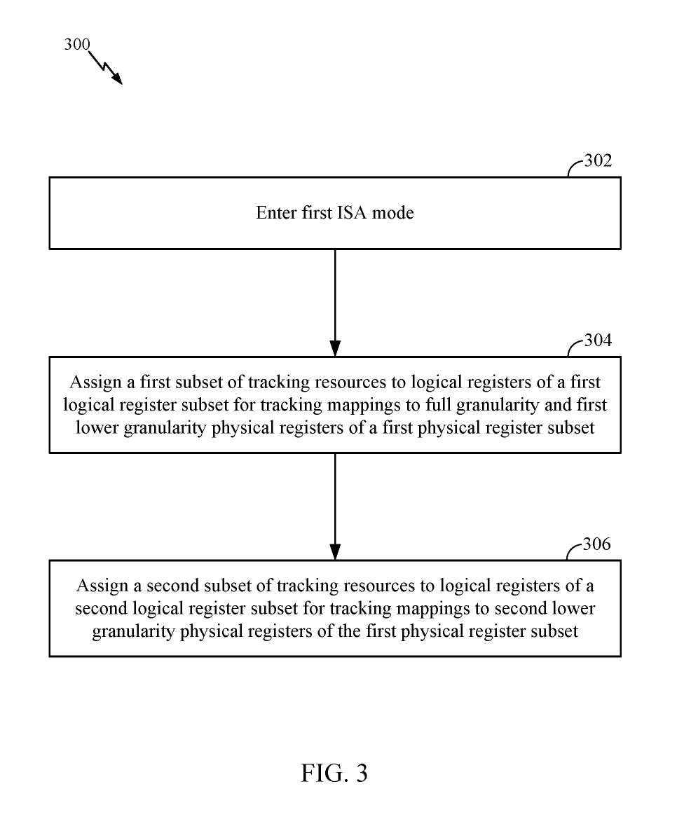

Accordingly, it will be appreciated that aspects include various methods for performing the processes, functions and/or algorithms disclosed herein. For example, FIG. 3 illustrates a method (300) of method of operating a processor (e.g., processor 100) according to exemplary aspects. The various steps or blocks of method 300 are explained below.

Block 302 comprises entering a first ISA mode. For example, Block 302 may involve entering an A32 mode in an ARM architecture.

In the first ISA mode, Block 304 comprises assigning a first subset of tracking resources to logical registers of a first logical register subset for tracking mappings to full granularity and first lower granularity physical registers of a first physical register subset. For example, in the ARM architecture, Block 304 may relate to assigning attributes, mode, etc. to logical registers R1-R16 of a first logical register subset 220 for tracking mappings to full granularity physical registers (wherein the full granularity physical registers may be 64-bit registers such as 64-bit physical registers P1-P16) and first lower granularity physical registers (wherein the first lower granularity physical registers may be lower 32-bit halves of 64-bit registers, such as 32-bit lower halves P1L-P16L of first physical register subset 224).

Block 306 comprises assigning a second subset of tracking resources to logical registers of a second logical register subset for tracking mappings to second lower granularity physical registers of the first physical register subset. For example, Block 306 comprises assigning a second subset of tracking resources to logical registers R17-R32 of second logical register subset 222 for tracking mappings to second lower granularity physical registers (wherein the second lower granularity physical registers may be upper 32-bit halves of 64-bit registers, such as 32-bit upper halves P1H-P16H of the first physical register subset 224).

In some aspects of method 300, the second subset of tracking resources are configured for tracking at least the logical registers of the second logical register subset mappings to physical registers (e.g., P17-Pn) of a second physical register subset (e.g., 226) of a second ISA mode (e.g., A64 mode), wherein the second physical register subset is available to the second ISA mode but not the first ISA mode.

Accordingly, it will also be appreciated that aspects of this disclosure may also be directed to a means for executing instructions in a first instruction set architecture (ISA) mode or a second ISA mode (e.g., processor 100). The means for executing can comprises a first means for tracking (e.g., attributes, mode, and/or other tracking resources assigned to logical registers R1-R16 of a first logical register subset 220 for tracking mappings), wherein the first means for tracking may be assigned to logical registers of a first logical register subset, for tracking mappings to full granularity physical registers and first lower granularity physical registers of a first physical register subset in the first ISA mode. The means for executing can also comprise a second means for tracking (e.g., attributes, mode, and/or other tracking resources assigned to logical registers R17-R32 of second logical register subset 222), wherein the second means for tracking may be assigned to logical registers of a second logical register subset for tracking mappings to second lower granularity physical registers of the first physical register subset in the first ISA mode. According to exemplary aspects, the second means for tracking for tracking can comprise means for tracking at least mappings of the logical registers of the second logical register subset to physical registers (e.g., P17-Pn) of a second physical register subset (e.g., 226) in the second ISA mode (e.g., A64 mode), wherein the second physical register subset is available to the second ISA mode but not the first ISA mode.

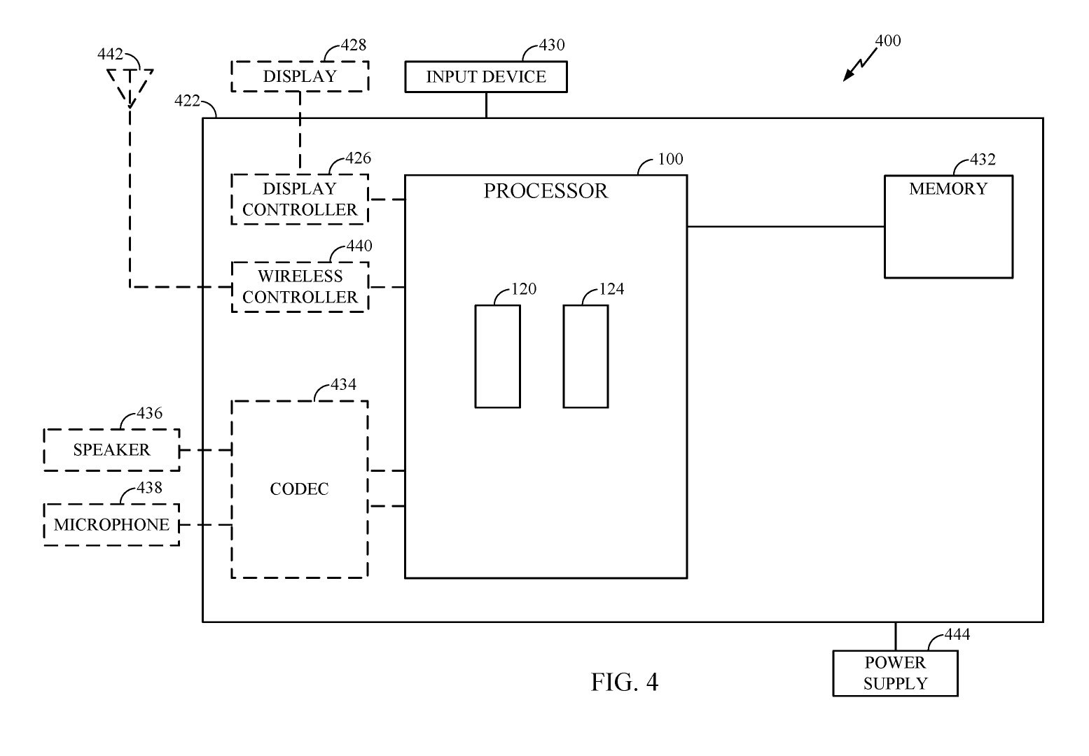

Referring to FIG. 4, a block diagram of a particular illustrative aspect of a computing device 400 according to exemplary aspects. Computing device 400 includes processor 100 described with reference to FIG. 1 (with only blocks representing exemplary structures corresponding to RMT 120 and PRF 124 shown for the sake of clarity in this representation). Computing device 400 may be configured to perform the method 300 of FIG. 3 in some aspects. As shown in FIG. 4, processor 100 may be in communication with memory 432.

In some aspects, computing device 400 may be integrated in a wireless communication device or employed for wireless communication. For example, computing device 400 may be integrated in a user terminal or a mobile device. In such aspects, computing device 400 may include the blocks shown in dashed lines to indicate that these blocks are optional. For example, the blocks shown as display 428, display controller 426, wireless antenna 442, wireless controller 440, speaker 436, microphone 438, and coder/decoder (CODEC) 434 may be optional. Accordingly, where present, display controller 426 may be coupled to processor 100 and to display 428; CODEC 434 (e.g., an audio and/or voice CODEC) can be coupled to processor 100; speaker 436 and microphone 438 can be coupled to CODEC 434; and wireless controller 440 (which may include a modem) can be coupled to wireless antenna 442. In a particular aspect, processor 100, display controller 426, memory 432, CODEC 434, and wireless controller 440 can be included in a system-in-package or system-on-chip device 422.

In a particular aspect, input device 430 and power supply 444 are coupled to the system-on-chip device 422. Moreover, in a particular aspect, as illustrated in FIG. 4, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 depicts a wireless communications device, processor 100 and memory 432 may also be integrated into a set top box, a music player, a video player, an entertainment unit, a navigation device, a personal digital assistant (PDA), a communications device, a fixed location data unit, a server, a computer or other similar electronic devices. Such devices may or may not include wireless capabilities. Further, at least one or more exemplary aspects of wireless device 500 may be integrated in at least one semiconductor die.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for handling a register file in different ISA modes. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of operating a processor, the method comprising:
in a first instruction set architecture (ISA) mode:
assigning a first subset of tracking resources to logical registers of a first logical register subset for tracking mappings to full granularity physical registers and first lower granularity physical registers of a first physical register subset; and
assigning a second subset of tracking resources to logical registers of a second logical register subset for tracking mappings to second lower granularity physical registers of the first physical register subset,
wherein the second subset of tracking resources are configured for tracking at least mappings of the logical registers of the second logical register subset to physical registers of a second physical register subset in a second ISA mode,
wherein the second physical register subset is available to the second ISA mode but not the first ISA mode.

2. The method of claim 1, wherein the first ISA mode is an A32 mode, the second ISA mode is an A64 mode.

3. The method of claim 2, wherein the full granularity physical registers are 64-bit registers, the first lower granularity physical registers are lower 32-bit halves of 64-bit registers, and the second lower granularity physical registers are upper 32-bit halves of 64-bit registers.

4. The method of claim 1, wherein the tracking resources comprise attributes which indicate granularity of access.

5. The method of claim 1, further comprising writing to a first lower granularity physical register or a second lower granularity physical register based on the first subset of tracking resources or the second subset of tracking resources, respectively.

6. The method of claim 5, comprising writing to the first lower granularity physical register or the second lower granularity physical register, without first reading data stored in the first lower granularity physical register or the second lower granularity physical register, respectively.

7. The method of claim 1, further comprising reading from a first lower granularity physical register or a second lower granularity physical register based on the first subset of tracking resources or the second subset of tracking resources, respectively.

8. The method of claim 7, further comprising shifting data read from the second lower granularity physical register to the first lower granularity physical register for a lower granularity read operation.

9. An apparatus comprising:
a processor configured to operate in a first instruction set architecture (ISA) mode or a second ISA mode, wherein the processor comprises a rename map table (RMT) configured to track logical register names to physical register names of physical registers of a physical register file (PRF), wherein the RMT comprises:
a first subset of tracking resources configured to track mappings of logical registers of a first logical register subset to full granularity physical registers and first lower granularity physical registers of a first physical register subset of the PRF in the first ISA mode; and
a second subset of tracking resources configured to track mappings of logical registers of a second logical register subset to second lower granularity physical registers of the first physical register subset of the PRF in the first ISA mode,
wherein the second subset of tracking resources are configured to track at least mappings of the logical registers of the second logical register subset to physical registers of a second physical register subset of the PRF in the second ISA mode,
wherein the second physical register subset is available to the second ISA mode but not the first ISA mode.

10. The apparatus of claim 9, wherein the first ISA mode is an A32 mode, the second ISA mode is an A64 mode.

11. The apparatus of claim 10, wherein the full granularity physical registers are 64-bit registers, the first lower granularity physical registers are lower 32-bit halves of 64-bit registers, and the second lower granularity physical registers are upper 32-bit halves of 64-bit registers.

12. The apparatus of claim 9, wherein the tracking resources comprise attributes which indicate granularity of access.

13. The apparatus of claim 9, wherein the processor comprises write logic configured to write to a first lower granularity physical register or a second lower granularity physical register based on the first subset of tracking resources or the second subset of tracking resources, respectively.

14. The apparatus of claim 1, further comprising read logic configured to read from a first lower granularity physical register or a second lower granularity physical register based on the first subset of tracking resources or the second subset of tracking resources, respectively.

15. The apparatus of claim 14, further comprising shift logic configured to shift data read from the second lower granularity physical register to the first lower granularity physical register for a lower granularity read operation.

16. An apparatus comprising:
means for executing instructions in a first instruction set architecture (ISA) mode or a second ISA mode, wherein the means for executing comprises:
a first means for tracking assigned to logical registers of a first logical register subset, for tracking mappings to full granularity physical registers and first lower granularity physical registers of a first physical register subset in the first ISA mode; and
a second means for tracking assigned to logical registers of a second logical register subset, for tracking mappings to second lower granularity physical registers of the first physical register subset in the first ISA mode,
wherein the second means for tracking for tracking comprises means for tracking at least mappings of the logical registers of the second logical register subset to physical registers of a second physical register subset in the second ISA mode,
wherein the second physical register subset is available to the second ISA mode but not the first ISA mode.

17. The apparatus of claim 16, wherein the first ISA mode is an A32 mode, the second ISA mode is an A64 mode.

18. The apparatus of claim 17, wherein the full granularity physical registers are 64-bit registers, the first lower granularity physical registers are lower 32-bit halves of 64-bit registers, and the second lower granularity physical registers are upper 32-bit halves of 64-bit registers.

19. A non-transitory computer-readable storage medium comprising code, which, when executed by a processor, causes the processor to manage tracking resources for logical registers in first and second instruction set architecture (ISA) modes, the non-transitory computer-readable storage medium comprising:
code for assigning, in the first ISA mode, a first subset of tracking resources to logical registers of a first logical register subset for tracking mappings to full granularity physical registers and first lower granularity physical registers of a first physical register subset; and
code for assigning, in the first ISA mode, a second subset of tracking resources to logical registers of a second logical register subset for tracking mappings to second lower granularity physical registers of the first physical register subset,
wherein the second subset of tracking resources are configured for tracking at least mappings of the logical registers of the second logical register subset to physical registers of a second physical register subset in a second ISA mode,
wherein the second physical register subset is available to the second ISA mode but not the first ISA mode.

20. The non-transitory computer-readable storage medium of claim 19, wherein the first ISA mode is an A32 mode, the second ISA mode is an A64 mode.

21. The non-transitory computer-readable storage medium of claim 20, wherein the full granularity physical registers are 64-bit registers, the first lower granularity physical registers are lower 32-bit halves of 64-bit registers, and the second lower granularity physical registers are upper 32-bit halves of 64-bit registers.

22. The non-transitory computer-readable storage medium of claim 1, wherein the tracking resources comprise attributes which indicate granularity of access.

23. The non-transitory computer-readable storage medium of claim 19, further comprising code for writing to a first lower granularity physical register or a second lower granularity physical register based on the first subset of tracking resources or the second subset of tracking resources, respectively.

24. The non-transitory computer-readable storage medium of claim 23, comprising code for writing to the first lower granularity physical register or the second lower granularity physical register, without first reading data stored in the first lower granularity physical register or the second lower granularity physical register, respectively.

25. The non-transitory computer-readable storage medium of claim 19, further comprising code for reading from a first lower granularity physical register or a second lower granularity physical register based on the first subset of tracking resources or the second subset of tracking resources, respectively.

26. The non-transitory computer-readable storage medium of claim 25, further comprising code for shifting data read from the second lower granularity physical register to the first lower granularity physical register for a lower granularity read operation.
